(19) United States
(12) Patent Application Publication
(10) Pub. No.: US 2019/0337213 A1
(43) Pub. Date: Nov. 7, 2019

(54) MULTIPLE EXTRUSION DIE HEAD

(71) Applicant: W. Müller GmbH, Troisdorf (DE)

(72) Inventor: Klaus LANG, Lohmar (DE)

(73) Assignee: W. Mùller GmbH, Troisdorf (DE)

(21) Appl. No.: 16/404,865

(22) Filed: May 7, 2019

(30) Foreign Application Priority Data
May 7, 2018 (EP) 18171095.5

(51) Int. Cl. B29C 48/325; B29C 48/10

(52) U.S. Cl. CPC B29C 48/325; B29C 48/10

(57) ABSTRACT

A multiple extrusion head for manufacturing parisons from thermoplastic material includes a stationary arranged base frame and a multiple of extrusion heads arranged on the base frame. Each of the extrusion heads has a material inlet, a ring die in fluid connection to the material inlet, an outer die element and an inner die element arranged coaxially to each other, an adjustment element displaceable along a longitudinal axis of the multiple extrusion head, and spring supports arranged between the base frame and the adjustment element. The spring supports are supported in a biased manner against the base frame and the adjustment element such that such that tilting moments between the extrusion heads is reduced.

### CROSS-REFERENCE TO RELATED APPLICATION

This application claims priority to and the benefit of European Patent Application No. EP 18171095.5 filed on May 7, 2018. The disclosure of the above application is incorporated herein by reference.

### FIELD

The present disclosure relates to a multiple extrusion head for manufacturing parisons from thermoplastic material.

### BACKGROUND

The statements in this section merely provide background information related to the present disclosure and may not constitute prior art.

A multiple extrusion head is for example known from DE 10 2007 030 677 A1. The multiple extrusion head described there serves to supply several extrusion heads, arranged in at least two parallel rows, starting from a material inlet connected to an extruder. The extrusion heads are arranged behind one another as well as next to each other.

In this case the adjustment element displaces the annular gap of all extrusion heads. For this, the adjustment element is guided displaceably via linear guides, for example by means of guide rods or guide posts and along the guide rods or guide posts displaceable spherical sleeves of common type, linearly guided along the longitudinal axis of the multiple extrusion head. Different pressure conditions in the material channels within the extrusion heads lead to the fact, that the counter-force, resulting from the pressure conditions within the material channels of the extrusion heads, deviates from the displacement force, which is produced by the drive onto the adjustment element, such, that the adjustment element is tilted relative to the base frame, i.e. relative to the longitudinal axis. This can lead to an increased wear up to the breakage of individual components.

The present disclosure addresses the issues of wear of extrusion head components among other issues related to multiple extrusion heads.

### SUMMARY

This section provides a general summary of the disclosure and is not a comprehensive disclosure of its full scope or all of its features.

In one form of the present disclosure, a multiple extrusion head for manufacturing parisons from thermoplastic material includes a stationary arranged base frame and several extrusion heads, arranged on the base frame. Each of the multiple extrusion heads has a material inlet for a material flow of plasticized material delivered by an extruder, a ring die for forming a tube-like layer of the parison, wherein the ring die is connected in fluid connection to the material inlet, and an outer die element and an inner die element, which are arranged coaxially to each other and which form an annular gap forming the ring die. At least one of the die elements is displaceable along an adjustment axis of the respective extrusion head for adjusting the gap width of the annular gap. The multiple extrusion head also includes an adjustment element, which is displaceable along the longitudinal axis of the multiple extrusion head and which is connected to the displaceable die elements of the extrusion heads. Furthermore, the multiple extrusion head has several spring supports arranged between the base frame and the adjustment element and supported in a biased manner on the base frame and the adjustment element. Accordingly, the spring supports apply force onto the adjustment element in a loading direction at several positions and these forces acting at several positions stabilize the adjustment element against tilting.

In one aspect of the present disclosure, the base frame has a base plate, to which the extrusion heads are attached. Furthermore, the adjustment element can have an adjustment plate, axially guided relative to the base frame. In this aspect the spring supports are arranged between the base plate and the adjustment plate and are supported against same.

In some aspects of the present disclosure, the drive can have a drive element displaceable along the longitudinal axis and connected to the adjustment element. In such aspects the spring supports can be arranged displaceably parallel to the longitudinal axis defined by the drive. Accordingly, the spring supports support the adjustment element laterally from the drive and stabilize the same. To ensure a best possible support against tilting, the spring supports can be arranged as far apart from each other as possible.

In another aspect of the present disclosure, the spring supports are connected rigidly to the base frame, especially to the base plate of the base frame, and act on the adjustment element such, that the spring supports are held only in contact with the adjustment element, without being connected thereto. Accordingly, angle deviations can be compensated. Also, an inverted arrangement is possible in which the spring supports are connected to the adjustment element and are acted upon into contact against the base plate.

Each of the spring supports can have a first spring support element and a second support element, which are displaceable axially to each other. The spring supports have a spring unit(s) arranged between the first support element and the second support element. Accordingly, the first support element and the second support element are acted upon by a force of the spring unit(s) away from each other and can for example be formed telescopically with each other.

To ensure a compact construction, the spring unit(s) can comprise a Belleville spring unit.

In some aspects of the present disclosure, the spring unit(s) can accommodate the Belleville spring unit in a space saving manner in a cylindrical accommodation chamber of the first support element. Generally, it is however also possible to arrange the accommodation chamber in the second support element.

In the accommodation chamber an accommodation mandrel can be arranged, onto which the spring unit, especially when these have a Belleville spring unit, is inserted. The spring unit and especially the individual Belleville springs of the Belleville spring unit are, thus, centered.

The second support element can have a cylindrical chamber, which is open in the direction to the first support element and which partially accommodates the first support element. Thus, the spring unit is encapsulated from the outside and is protected from outside influences.

For attaching the spring support, the first support element can have a threaded trunnion, which is arranged on a side of the first support element facing away from the second support element and is screwed into a threaded bore of the base frame, especially the base plate. It is also possible, that the second support element has the threaded trunnion. Furthermore, the threaded trunnion can also be screwed into a threaded bore of the adjustment element.

In aspects of the present disclosure with the threaded trunnion on the first support element, the second support element can form a support face, by which the second support element is acted upon against the adjustment element. In aspects of the present disclosure with threaded trunnion on the second support element, the first support element is provided with the support face.

The support face can be part of a support head and the support head can be attached axially displaceably. Because of the axial displaceability of the support head, the length of the spring support can be displaced to a maximally retracted or maximally extended position. Thus, the biasing, with which the spring support is held between the base plate and the adjustment element, can be adjusted.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a side view of a multiple extrusion head according to the teachings of the present disclosure;

FIG. 2 is a side view of the adjustment plate and the base plate of the multiple extrusion head of FIG. 1, with spring supports arranged therebetween in an enlarged view;

FIG. 3 is an enlarged representation of the first extrusion head of the multiple extrusion head of FIG. 1 in the area of the ring die in longitudinal sectional view;

FIG. 4 is a longitudinal sectional view of the first spring support of the multiple extrusion head of FIG. 1 in an extended position; and

FIG. 5 is a longitudinal sectional view of the first spring support of FIG. 4 in a retracted position.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features. Examples are provided to fully convey the scope of the disclosure to those who are skilled in the art. Numerous specific details are set forth such as types of specific components, devices, and methods, to provide a thorough understanding of variations of the present disclosure. It will be apparent to those skilled in the art that specific details need not be employed and that the examples provided herein, may include alternative aspects or forms and are not intended to limit the scope of the disclosure. In some examples, well-known processes, well-known device structures, and well-known technologies are not described in detail.

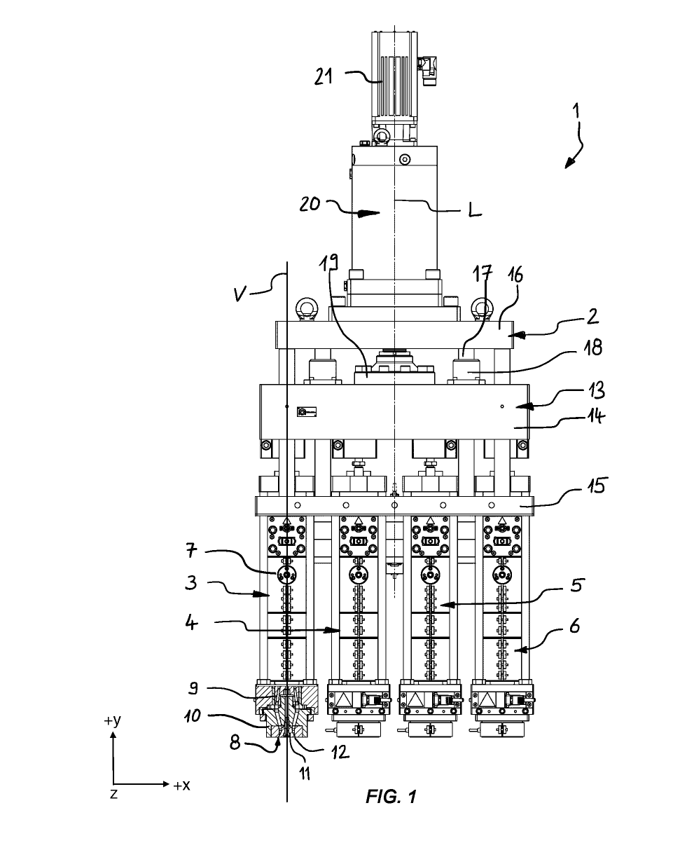

FIGS. 1 to 3 show an extrusion head 1 according to the present disclosure in different views and are described in the following together.

The multiple extrusion head 1 has a base frame 2, arranged stationary. Four extrusion heads, namely a first extrusion head 3, a second extrusion head 4, a third extrusion head 5 and a fourth extrusion head 6, are attached to the base frame 2. The multiple extrusion head 1 has a longitudinal axis L, wherein the extrusion heads 3, 4, 5, 6 are arranged next to each other transversally to the longitudinal axis L in a row and extend parallel to the longitudinal axis L from the base frame 2 in the shown representation vertically downwards. Generally, the multiple extrusion head 1 can, however, also be used in a different position, for example in a position, in which the longitudinal axis L is not vertically arranged as depicted in FIGS. 1 to 3, but is horizontally arranged.

The extrusion heads 3, 4, 5, 6 are designed similarly and/or identically, i.e., in the following the first extrusion head 3 is described exemplary representative also for the other extrusion heads 4, 5, 6.

The first extrusion head 3 has a material inlet 7, which is connected to an extruder not shown here, so that a material flow of plasticized material can be supplied to the first extrusion head 3.

The material inlets 7 of all extrusion heads 3, 4, 5, 6 can be connected via a distributor arrangement to a joint extruder. It is also possible, that each extrusion head 3, 4, 5, 6 is fed by a separate extruder.

In the first extrusion head 3 a material channel 9 is arranged, which connects the material inlet 7 in a fluid connection to a ring die 8, so that the material flow is guided to the ring die 8 and exits tube-like there from an annular gap 12 formed by the ring die 8. Thus, a tube-like parison is formed.

In the present case, exactly one ring die 8 is provided with an annular gap 12. Thus, a one-layered parison is manufactured. However, it is also possible, that the first extrusion head 3 has several material inlets, which are connected respectively to a separate extruder, wherein the material channels are connected via different material channels to several ring dies. This would allow the manufacture of multi-layered tube-like parisons. In this case it is also possible, that one of the annular gaps is arranged within the extrusion head, so that the different layers are guided to each other within the extrusion head and are expelled together through a further ring die.

The ring die 8 has an outer die element 10 and an inner die element 11, between which the annular gap 12 is formed. In some aspects of the present disclosure, the outer die element 10 is arranged stationary and the inner die element 11 is arranged axially displaceable along an adjustment axis V, which is arranged parallel to the longitudinal axis L of the multiple extrusion head 1. The inner die element 11 can axially be displaced between a retracted position (+y direction), shown in FIG. 3, and a downward (−y direction) extended position. In the retracted position the annular gap 12 is closed, so that no plasticized material can exit. In the downward extended position, the annular gap 12 has its largest gap width (x direction) and enables an expelling of the tube-like material flow. By displacing the inner die element 11 between the retracted position and the extended position, the gap width of the annular gap 12 can be gradually changed, so that by means of this the wall thickness of the manufactured parison can be varied.

The outer die element 10 has towards the annular gap 12 an inner face 37, which is arranged coaxially to the adjustment axis V (FIG. 1) and which in the cross-sectional view of FIG. 3 is formed convexly inwards towards the adjustment axis V. In the area of the annular gap 12, the inner face 37 is thus formed such that it expands towards the annular gap 12.

The inner die element 11 has towards the annular gap 12 an outer face 38 arranged coaxially to the adjustment axis V and which in the cross-sectional view of FIG. 3 is formed concavely in relation to the adjustment axis. In the area of the annular gap 12, the outer face 38 is thus formed such that it also expands towards to the annular gap 12.

Furthermore, the diameters of the outer die element 10 and of the inner die element 11 are the same at their axial ends, in FIG. 3 vertically at the bottom (−y direction), so that in the retracted position of FIG. 3, in which the outer die element 10 and the inner die element 11 are arranged flush to each other, the annular gap 12 is closed. If the inner die element 11 is now moved vertically downwards, the annular gap 12 opens gradually in dependency of the vertical position of the inner die element 11, so that a tube-like parison made from thermoplastic material is expelled. The wall thickness of the parison can also be adjusted by means of the vertical position of the inner die element 11.

For adjusting the inner die element 11, an adjustment element 13 is provided with an adjustment plate 14. The adjustment plate 14 extends transversally to the longitudinal axis L and is arranged between a base plate 15 of the base frame 2 and a cover plate 16 of the base frame 2. The base plate 15 and the cover plate 16 are also arranged transversally to the longitudinal axis L and are connected to each other via guide posts 17. The adjustment plate 14 has for each guide post 17 a spherical sleeve 18, which rests on one of the guide posts 17 and is axially displaceable parallel to the longitudinal axis L. Via the spherical sleeves 18, rigidly connected to the adjustment plate 14, the adjustment plate 14 can thus be displaced between the base plate 15 and the cover plate 16 axially along the longitudinal axis L.

For the adjustment a drive 20 with a drive motor 21 is provided. The drive 20 is attached on the side, facing away from the adjustment plate 14, on the cover plate 16. Furthermore, the drive 20 is connected to a drive element 19, which is connected to the adjustment plate 14. Via the drive 20, the drive element 19 and thus the adjustment plate 14 can be displaced along the longitudinal axis L.

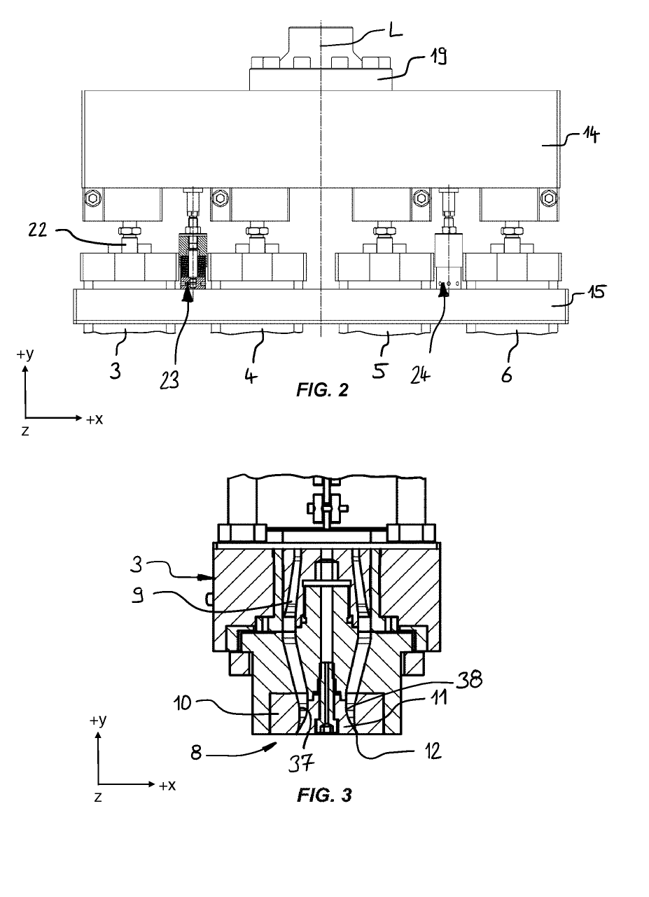

On the side of the adjustment plate 14, facing away from the drive 20, the adjustment plate 14 is connected for each extrusion head 3, 4, 5, 6 to a mandrel 22 (FIG. 2). Furthermore, the mandrel 22 of the first extrusion head 3 is connected to the inner die element 11 of the ring die 8. Thus, by means of displacing the adjustment plate 14 via the mandrel 22, the inner die element 11 can be axially adjusted.

During operation it can happen, that within the material channel 9 of the individual extrusion heads 3, 4, 5, 6 different pressures are present. This leads to the fact, that especially during closing of the ring dies 8 different forces are necessary for each extrusion head 3, 4, 5, 6. In an exemplary case, in which the pressure in the material channel 9 of the first extrusion head 3 is distinctly lower than the pressure in the material channel of the fourth extrusion head 6, during closing of the ring dies 8 of the inner die element 11 a higher counter-pressure is counteracting the drive, than of the inner die element 11 of the first extrusion head 3. Thus, a tilting of the adjustment plate 14 is produced clock-wise in the in FIG. 1 shown view. This tilting can lead to a higher wear of the guide posts 19 and of the spherical sleeves 18, however it can also lead in an extreme case to a wear or even breakage of the mandrels 22.

To reduce the danger of increased wear or even of the breakage, in some aspects of the present disclosure a first spring support 23 and a second spring support 24 are arranged between the base plate 15 and the adjustment plate 14. The spring supports 23, 24 are biased between the base plate 15 and the adjustment plate 14 and push these away from each other. Furthermore, the spring supports 23, 24 are arranged distanced from each other so far, that the adjustment plate 14 is stabilized against tilting. In some aspects of the present disclosure the drive 20 and thus the imaginary longitudinal axis L is arranged centrally. The extrusion heads 3, 4, 5, 6 are arranged in the view shown in FIG. 1 in pairs on one side of the longitudinal axis L and mirror-symmetrically to the longitudinal axis L (e.g., extrusions heads 3, 4 on one side (−x direction) of the longitudinal axis L and extrusions heads 5, 6 on another side (+x direction) of the longitudinal direction). The spring supports 23, 24 are arranged on opposite sides of the longitudinal axis L, also mirror-symmetrically to the longitudinal axis L. In this case, each of the spring supports 23, 24 are arranged between two of the extrusion heads 3, 4, 5, 6 (e.g., spring support 23 is arranged between extrusion heads 3 and 4, and spring support 24 is arranged between extrusion heads 5 and 6). Arrangement of the spring supports 23, 24 laterally off-set from the longitudinal axis L counter-acts possible tilting moments.

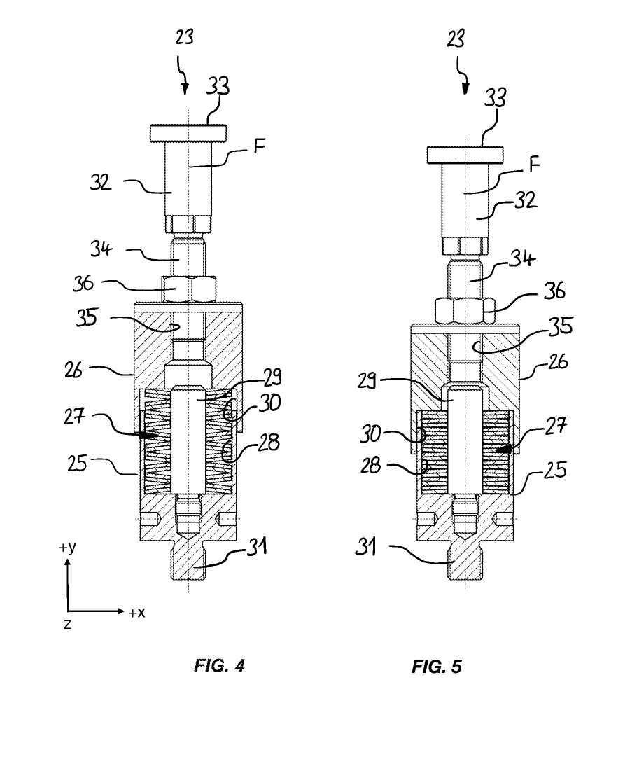

In some aspects of the present disclosure, the two springs are designed similarly and/or identically. In such aspects, the first spring support 23 is described in more detail using FIGS. 4 and 5.

The first spring support 23 has a first support element 25 and a second support element 26, which are acted upon by a force away from each other by the spring unit, e.g., a Belleville spring unit 27. In FIG. 4, the first spring support 23 is shown in an extended position and in FIG. 5 in a retracted position. The two support elements 25, 26 are displaceable axially relative to each other along a spring support axis F. The spring support axis F is arranged parallel to the longitudinal axis L.

The Belleville spring unit 27 is arranged in a cylindrical accommodation chamber 28 of the first support element 25. In the accommodation chamber 28, an accommodation mandrel 29 is arranged centrally, which is arranged coaxially to the spring support axis F and onto which the Belleville spring unit 27 is mounted.

The second support element 26 has a cylindrical chamber 30, which is open towards the first support element 25 and which accommodates partially the first support element 25. The two support elements 25, 26 are thus retractable telescopically into one another. Furthermore, the accommodation chamber 28 is closed towards the outside, so that the Belleville spring unit 27 is protected against external influences. The Belleville spring unit 27 is supported on a bottom (−y direction) of the accommodation chamber 28 of the first support element 25 and on a top (+y direction) of the cylindrical chamber 30 of the second support element 26 and pushes the same apart.

On a side of the first support element 25, facing away (−y direction) from the second support element 26, the first support element 25 has a threaded trunnion 31, which is arranged coaxially to the spring support axis F. The threaded trunnion 31 is screwed into a (not shown here) threaded bore of the base plate 15, so that the first spring support 23 is rigidly connected to the base plate 15 and thus to the base frame 2.

On a side, facing away (+y direction) from the first support element 25, the second support element 26 has a support head 32, which forms a support face 33, which is acted upon by a force into abutment to the adjustment plate 14. Thus, the adjustment plate 14 is acted upon by a force away from the base plate 15. In some aspects of the present disclosure, the support face 33 is arranged in a face to face contact to the adjustment plate 14.

To be able to compensate certain angle deviations, the support head 32 is connected in an articulated manner to a threaded trunnion 34. The threaded trunnion 34 is screwed coaxially to the spring support axis F into a threaded bore 35 of the second support element 26. In this case, the threaded trunnion 34 can be threaded differently deep into the threaded bore 25, so that the distance of the support face 33 to the second support element 26 can be adjusted. Thus, the biasing of the first spring support 23 between the base plate 15 and the adjustment plate 14 can be adjusted. For securing the position of the threaded trunnion 34 and thereby securing the distance between the support face 33 and the second support element 26, a locknut 36 is screwed onto the threaded trunnion 34, which can be locked against the second support element 26.

When an element or layer is referred to as being “on,” “engaged to,” or “coupled to,” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used to describe various elements, components, regions, layers and/or sections, these elements, components, regions, layers and/or sections, should not be limited by these terms. These terms may be only used to distinguish one element, component, region, layer and/or section, from another element, component, region, layer and/or section. Terms such as “first,” “second,” and other numerical terms when used herein do not imply a sequence or order unless clearly indicated by the context. Thus, a first element, component, region, layer or section, could be termed a second element, component, region, layer or section without departing from the teachings of the example forms. Furthermore, an element, component, region, layer or section may be termed a “second” element, component, region, layer or section, without the need for an element, component, region, layer or section termed a “first” element, component, region, layer or section.

Spacially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above or below. The device may be otherwise oriented (rotated 90 degrees or at other orientations) and the spatially relative descriptors used herein interpreted accordingly.

As used herein, the phrase at least one of A, B, and C should be construed to mean a logical (A OR B OR C), using a non-exclusive logical OR, and should not be construed to mean “at least one of A, at least one of B, and at least one of C.

The terminology used herein is for the purpose of describing particular example forms only and is not intended to be limiting. The singular forms “a,” “an,” and “the” may be intended to include the plural forms as well, unless the context clearly indicates otherwise. The terms “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, examples that do not depart from the substance of the disclosure are intended to be within the scope of the disclosure. Such examples are not to be regarded as a departure from the spirit and scope of the disclosure. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A multiple extrusion head for manufacturing parisons from thermoplastic material, comprising:
a stationary arranged base frame,
a multiple of extrusion heads arranged on the base frame, each extrusion head comprising:
a material inlet for a material flow of plasticized material delivered by an extruder,
a ring die for forming a tube-like layer of the parison, wherein the ring die is connected in fluid connection to the material inlet, and
an outer die element and an inner die element arranged coaxially to each other and forming an annular gap of the ring die, wherein at least one of the die elements is displaceable along an adjustment axis of the respective extrusion head for adjusting the gap width of the annular gap, as well as an adjustment element which is displaceable along a longitudinal axis of the multiple extrusion head and which is connected to the displaceable die elements of the extrusion heads, and
spring supports arranged between the base frame and the adjustment element, wherein the spring supports are supported in a biased manner against the base frame and the adjustment element.

2. The multiple extrusion head according to claim 1, wherein the base frame has a base plate on which the extrusion heads are attached, the adjustment element has an adjustment plate axially guided relative to the base frame, and the spring supports are arranged between and supported against the base plate and the adjustment plate.

3. The multiple extrusion head according to claim 1, wherein a drive has a drive element displaceable along the longitudinal axis and connected to the adjustment element.

4. The multiple extrusion head according to claim 1, wherein the spring supports are arranged displaceably parallel to the longitudinal axis.

5. The multiple extrusion head according claim 1, wherein the spring supports are connected to the base frame and biased in contact to the adjustment element.

6. The multiple extrusion head according claim 1, wherein the spring supports each have a first spring support element and a second support element displaceably axially to each other and a spring unit arranged between the first support element and the second support element.

7. The multiple extrusion head according to claim 6, wherein the spring unit comprises a set of Belleville springs.

8. The multiple extrusion head according claim 6, wherein the first support element has a cylindrical accommodation chamber accommodating the spring unit.

9. The multiple extrusion head according to claim 8 further comprising an accommodation mandrel arranged in the accommodation chamber, wherein the accommodation mandrel receives the spring unit.

10. The multiple extrusion head according to claim 6, wherein the second support element has a cylindrical chamber which is open in a direction towards the first support element and which partially accommodates the first support element.

11. The multiple extrusion head according to claim 6, wherein the first support element has a threaded trunnion arranged on a side of the first support element facing away from the second support element and is screwed into a threaded bore of the base frame.

12. The multiple extrusion head according to claim 6, wherein the second support element has a support face with which the second support element acts on the adjustment element.

13. The multiple extrusion head according to claim 12, wherein the support face is part of a support head, wherein the support head is axially displaceable.

14. A multiple extrusion head for manufacturing parisons from thermoplastic material, comprising:
a stationary arranged base frame,
a multiple of extrusion heads arranged on the base frame, each extrusion head comprising:
a material inlet for a material flow of plasticized material delivered by an extruder,
a ring die for forming a tube-like layer of the parison, wherein the ring die is connected in fluid connection to the material inlet, and
an outer die element and an inner die element are arranged coaxially to each other and forming an annular gap of the ring die, wherein at least one of the die elements is displaceable along an adjustment axis of the respective extrusion head for adjusting the gap width of the annular gap, as well as an adjustment element which is displaceable along a longitudinal axis of the multiple extrusion head and which is connected to the displaceable die elements of the extrusion heads,
spring supports arranged between the base frame and the adjustment element, wherein the spring supports are supported in a biased manner against the base frame and the adjustment element, and
a drive comprising a drive element displaceable along the longitudinal axis and connected to the adjustment element.

15. The multiple extrusion head according to claim 14, wherein the base frame has a base plate on which the extrusion heads are attached, the adjustment element has an adjustment plate axially guided relative to the base frame, and the spring supports are arranged between and supported against the base plate and the adjustment plate, and the spring supports.

16. The multiple extrusion head according claim 14, wherein the spring supports each have a first spring support element and a second support element displaceable axially to each other and a spring unit arranged between the first support element and the second support element.

17. The multiple extrusion head according claim 16, wherein the first support element has a cylindrical accommodation chamber accommodating the spring unit and the second support element has a cylindrical chamber which is open in a direction towards the first support element and which partially accommodates the first support element.

18. The multiple extrusion head according to claim 16, wherein the first support element has a threaded trunnion arranged on a side of the first support element facing away from the second support element and is screwed into a threaded bore of the base frame.

19. A multiple extrusion head for manufacturing parisons from thermoplastic material, comprising:
a multiple of extrusion heads arranged on the base frame, each extrusion head comprising:
a material inlet for a material flow of plasticized material delivered by an extruder,
a ring die for forming a tube-like layer of the parison, wherein the ring die is connected in fluid connection to the material inlet, and
an outer die element and an inner die element are arranged coaxially to each other and forming an annular gap of the ring die, wherein at least one of the die elements is displaceable along an adjustment axis of the respective extrusion head for adjusting the gap width of the annular gap, as well as an adjustment element comprising an adjustment plate axially guided relative to the base frame and displaceable along a longitudinal axis of the multiple extrusion head and which is connected to the displaceable die elements of the extrusion heads, and
a first spring support element and a second spring support element arranged between and supported against the base frame and the adjustment element displaceably parallel to the longitudinal axis, and supported in a biased manner against the base frame and the adjustment element.

20. The multiple extrusion head according to claim 19, wherein the first support element has a cylindrical accommodation chamber accommodating a spring unit and an accommodation mandrel is arranged in the accommodation chamber and the accommodation mandrel receives the spring unit.
